(19) United States
(12) Patent Application Publication
(10) Pub. No.: US 2023/0309594 A1
(43) Pub. Date: Oct. 5, 2023

(54) SWEETENER COMPOSITION

(71) Applicant: CARGILL, INCORPORATED, Wayzata, MN (US)

(72) Inventors: Ben ALEXANDRE, Eppegem (BE); Abdelfattah BENSOUISSI, Vilvoorde (BE); Nick VAES, Vilvoorde (BE)

(73) Assignee: CARGILL, INCORPORATED, Wayzata, MN (US)

(21) Appl. No.: 17/905,960

(22) PCT Filed: Mar. 9, 2021
(86) PCT No.: PCT/US2021/021570

§ 371 Date: Sep. 9, 2022

(30) Foreign Application Priority Data
Mar. 9, 2020 (EP) 20161793.3

(51) Int. Cl. A23L 27/30; A23L 29/30

(52) U.S. Cl. CPC A23L 27/33; A23L 29/30

(57) ABSTRACT

The present invention relates to a sweetener composition and a process for preparing a sweetener composition. In particular, the present invention relates to a sweetener composition comprising a crystalline carbohydrate and a bulking agent for replacing all or part of the sugar in a food product and preparing said sweetener composition. The present invention also relates to a process for reducing the hygroscopicity of resistant dextrin.

### CROSS-REFERENCE TO RELATED APPLICATIONS

This application claims the benefit of European Patent Application No. 20161793.3, filed Mar. 9, 2020, which is hereby incorporated by reference in its entirety.

### FIELD OF THE INVENTION

The present invention relates to a sweetener composition and a process for preparing a sweetener composition. In particular, the present invention relates to a sweetener composition comprising a crystalline carbohydrate and a bulking agent for replacing all or part of the sugar in a food product and preparing said sweetener composition.

### BACKGROUND

There is an increasing preference amongst consumers for “healthier” food products containing less sugar and/or calories than conventional food products. This has created a high demand for low sugar and low calorie or non-calorie alternatives.

Sugar, typically sucrose, is widely used as a food ingredient and serves several functions. Most importantly, it provides sweetness. It also provides bulk and plays a significant role in the structure, volume and mouthfeel of the finished food product. Formulating foods without sugar is challenging because a sugar replacement must fulfil all these various functions and perhaps more.

One approach has been to replace sugar with high-intensity sweeteners. However, such sweeteners can negatively impact flavour by causing a perceived “off-taste” and would require a substantial amount of bulking agent as the high intensity sweetener will not bring any texture to the product where it is added. Polyols have also been used for sugar replacement, however they are typically less sweet than sugar and at high dosages can have negative gastrointestinal side effects.

Bulking agents including starches or fibres have also been used to replace part of the sugar content in food. However, the use of bulking agents has been known to reduce sweetness.

WO2017093302, WO2017093309, WO2018100059, WO2018224546, WO2018224539, WO2018224534, WO2018224534, WO2018224537, WO2018224546, WO2018224542, and WO2018224541 disclose sugar replacers comprising amorphous porous particles and processes of preparing the amorphous porous particles for use in food and beverage products. The amorphous porous particles comprise sweetener, a bulking agent, and optionally a surfactant. However, these amorphous porous particles have a number of disadvantages. For example, they are thermodynamically unstable resulting in inconsistent product quality and poor shelf-life. They are also very hygroscopic leading to increased instances of lumping and stickiness, which in turn leads to difficulties with storage and processing (e.g. milling, spray drying). This last property has to be countered by cooling the product and placing it in a water-proof container immediately after drying, and also by using dehumidified air during processing. The manufacturing process for the particles is generally not cost-effective, for example because it involves dissolving the particles in water and then spray drying to remove the water, spray drying being an expensive process. The porous nature of the particles also causes them to hold fat, meaning that fat-based food products, such as chocolate, which contain the particles can have increased calorie content, and may therefore be considered less healthy.

There remains a need for a composition which can be used to replace all or part of the sugar in food, and which avoids or ameliorates the aforementioned disadvantages. The present invention seeks to fulfil this need.

The sweetener composition of the present invention has a number beneficial characteristics that make it superior to the amorphous porous particles described above. From the perspective of an ingredient manufacturer, the process for manufacturing the sweetener composition of present invention is better because it is simple, more cost-effective than the above-mentioned prior art process, and easy to implement, and results in a stable, shelf-stable, product that can be easily packaged. From the perspective of a food product manufacturer, the sweetener composition of the present invention is an easier ingredient to process because it has low stickiness, meaning that there is less need for frequent cleaning of equipment and machines, less product losses, and storage under standard conditions in a warehouse prior to use is made possible.

In use, the sweetener composition has comparable sweetness and texture/mouthfeel to pure sugar at a comparable weight whilst providing an advantageous reduction in calories, increased fibre content, and a reduced particle size that makes it particularly suitable for use in high quality chocolates, but also in other cocoa-containing compositions (coatings, fillings, powdered beverages etc.).

### STATEMENTS OF INVENTION

In one aspect, the present invention provides a process for preparing a sweetener composition comprising one or more crystalline carbohydrate(s), the process comprising:
obtaining a solution of one or more carbohydrate(s) dissolved in a solvent, and
combining the solution with one or more bulking agent(s) and optionally one or more crystalline carbohydrate(s), to form a mixture, and
adjusting the temperature and/or concentration and/or solubility conditions of the solution and/or mixture such that crystallization of the carbohydrate occurs and a sweetener composition comprising one or more crystalline carbohydrate(s) is obtained.

Optionally, the solution obtained is saturated with at least one of the one or more carbohydrate(s), and/or the process further comprises a step of forming a solution saturated with at least one of the one or more carbohydrate(s).

Optionally, the process further comprises a step of drying the sweetener composition.

Optionally, any two or more of the steps of the process may occur simultaneously, sequentially, or non-sequentially.

Optionally, the temperature is adjusted by cooling the mixture, and/or the concentration is adjusted by evaporating and/or applying a vacuum to the mixture, and/or the solubility is adjusted by adding an antisolvent.

Optionally, the bulking agent comprises insoluble and/or soluble fibre. The insoluble fibre may be selected from the group consisting of dietary fibre, cereal bran, oat fibre, bamboo fibre, fruit fibres, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose (for example from elephant grass), chitosan, pectins, gums, mucilages, lignins, compositions comprising the same or combinations thereof. The soluble fibre may be selected from the group consisting of resistant dextrin, resistant/modified maltodextrin, polydextrose, β-glucan, galactomannan, fructo-oligosaccharides, gluco-oligosaccharide, galacto-oligosaccharides, MOS (mannose-oligosaccharides), pectin, psyllium, inulin, resistant starch, compositions comprising the same or combinations thereof. Advantageously, the bulking agent comprises or (essentially) consists of soluble fibre selected from the group consisting of resistant dextrin.

Optionally, the carbohydrate may be selected from the group consisting of monosaccharides, disaccharides, polyols, and any combination thereof. Preferably, the carbohydrate is sucrose.

Optionally, the carbohydrate solution has a first temperature and the bulking agents(s) has a second temperature that is lower than the first temperature such that the mixture obtained by combining the carbohydrate solution with the one or more bulking agent(s) has an intermediate temperature, wherein the intermediate temperature is such that crystallization occurs.

Optionally, one or more of the process steps are carried out using a dryer, optionally a fluidized bed dryer.

Optionally, combining involves forming a suspension.

Optionally, the sweetener composition has a D90 particle size of 150 microns or less.

Optionally, at least 50% of the carbohydrate in the sweetener composition is in crystalline form.

Advantageously, the sweetener composition prepared according to the process of the invention consists of or essentially consists of bulking agent, preferably soluble fibre e.g. resistant dextrin, and crystalline carbohydrate, preferably sucrose. Advantageously, the sweetener composition consists of or essentially consists of one bulking agent, preferably soluble fibre e.g. resistant dextrin, and one crystalline carbohydrate, preferably sucrose.

In another aspect, the present invention provides a sweetener composition.

In another aspect, the present invention provides a sweetener composition obtained or obtainable by the process of the present invention.

In another aspect, the present invention provides a food product comprising the sweetener composition of the present invention.

In another aspect, the present invention provides the use of the sweetener composition of the present invention to replace sugar and/or fat in a food product, and/or to enrich the food product with fibre.

In another aspect, the process of the present invention can also be used as a process for reducing the hygroscopicity or stickiness of resistant dextrin.

### DESCRIPTION OF THE FIGURES

FIG. 1 is a phase diagram of a given solute (for instance a sugar) in a given solvent (for instance water, including water mixed with an antisolvent).

FIG. 2 (a-f) are images obtained from an electron microscope of sweetener compositions according to the invention G1-G6 as presented in the example section.

FIG. 3 (a-f) are images obtained from an electron microscope of sweetener compositions according to the invention R1-R6 as presented in the example section.

FIG. 4 (a-h) are images obtained from an electron microscope of sweetener compositions according to the invention, namely A1, A1′, A2, A2′, A3, A3′, A4 and A4′ as presented in the example section.

FIG. 5 shows the correlation of sweetness versus off-taste of sweetener compositions as presented in the example section.

### DETAILED DESCRIPTION OF THE INVENTION

Unless otherwise specified, all terms should be accorded a technical meaning consistent with the usual meaning in the art as understood by the skilled person.

All ratios and percentages in the present description correspond to dry weight percent unless otherwise specified.

All parameter ranges include the end-points of the ranges and all values in between the end-points, unless otherwise specified.

When used in this specification and claims, the terms “comprises” and “comprising” and variations thereof mean that the specified features, steps or integers are included. The terms are not to be interpreted to exclude the presence of other features, steps or components.

The term “sugar” is used herein to refer generally to naturally occurring sugars that are traditionally used in food production, especially baking and confectionary making. Typically “sugar” means sucrose, but other naturally occurring monosaccharides and disaccharides and mixtures thereof are also meant to be included by this term.

### Sweetener Composition

As used herein, the term “sweetener composition” is used to refer to a combination of ingredients that may be used to impart sweetness to a food product. The sweetener composition of the present invention may be used to wholly or partly replace sugar (e.g. sucrose, lactose etc.) in a recipe for a food product thereby reducing the total sugar content of the food product. As sugar is high in calories, this replacement also reduces the total calorie content of the food product.

The sweetener composition of the present invention is a sweetener composition comprising one or more crystalline carbohydrates.

The term “crystalline” is used herein to mean that at least 50% of the carbohydrate (as defined below) has a crystalline (i.e. non-amorphous) structure. Advantageously, around 100% (for example, at least 99% 98%, 97% 96%, or 95%) of the carbohydrate molecules are crystalline, meaning that the carbohydrate is free or essentially free of amorphous regions. Using currently available crystallization techniques it is expected that a trace amount of amorphous material may still be present. According to the present invention, the bulking agent preferably will not crystallize.

The sweetener composition of the present invention comprises one or more “bulking agent(s)”. Bulking agents may be selected to fulfil some of the functions of sugar and/or because of their individual chemical and physical properties which may affect the organoleptic or rheological properties of the food. In the context of the present invention, the term “bulking agent” is synonymous with the term “filler”. Any suitable bulking agent known in the art may be used in accordance with the present invention. Advantageously, the bulking agent is fibre, including soluble and/or insoluble fibre. General health advice encourages a diet high in fibre, so the use of fibre as a food ingredient might be particularly attractive to health conscious consumers. Moreover, the use of insoluble fibre is a sustainable alternative, as these are often obtained from by-products in the food industry.

Non-limiting examples of “insoluble fibre” that may be used in accordance with the present invention are dietary fibre, cereal bran, oat fibre, bamboo fibre, fruit fibre, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose (for example from elephant grass), chitosan, pectins, gums, mucilages, lignins, compositions comprising the same or combinations thereof. Insoluble fibres, such as wheat bran, can be obtained in micronized form having reduced particle size, for use in the present invention.

Non-limiting examples of “soluble fibre” that may be used in accordance with the present invention are resistant dextrin, such as Promitor® from Tate & Lyle, resistant/modified maltodextrin, polydextrose, β-glucan, galactomannan, fructo-oligosaccharides, gluco-oligosaccharide, galacto-oligosaccharides, MOS (mannose-oligosaccharides, also known in the art as mannan-oligosaccharides or manno-oligosaccharides), pectin, psyllium, inulin, resistant starch, compositions comprising the same or combinations thereof. The soluble fibre may for example be Nutriose® from Roquette. The resistant dextrin or polydextrose can also be obtained according to the process described in WO2011/091962, which is incorporated herein by reference. The soluble fibre can also be a MOS obtainable according to the processes described in WO2018/232078, which is incorporated herein by reference.

To improve the efficiency of the process of the invention when using soluble fibres, it is preferred that the soluble fibre when prepared is dried to the right granulometry to avoid the need for further particle size reduction at a later stage.

Advantageously, the bulking agent comprises or (essentially) consists of soluble fibre selected from the group consisting of resistant dextrin. It has been surprisingly found that by preparing the sweetener composition according to the invention using resistant dextrin, the resistant dextrin becomes much easier to handle and transport. Normally resistant dextrin powders are very highly hygroscopic and may cause stickiness when used in a production line to prepare certain foods. However, by blending with sugar according to the process of the invention it has been found that the sweetener composition comprising resistant dextrin is no longer as hygroscopic or as sticky as resistant dextrin alone and it becomes much easier to handle and incorporate into a recipe. Thus in one aspect of the invention, the process of the present invention can also be used as a process for reducing the hygroscopicity or stickiness of resistant dextrin.

Insoluble and soluble fibre may be used in any combination in the sweetener compositions and the processes of preparing the sweetener compositions according to the present invention.

The sweetener composition of the present invention also comprises one or more “carbohydrate(s)”.

The term “carbohydrate” as used herein refers to any type of carbohydrate that may crystallise and which is suitable for use in food. Non-limiting examples of carbohydrates that may be used in the present invention include monosaccharides, such as glucose, fructose, or galactose; disaccharides such as sucrose, lactose or maltose; and polyols such as sorbitol, mannitol, maltitol, xylitol, erythritol, or isomalt. Advantageously, the carbohydrate is sucrose.

The term “sucrose” as used herein includes sucrose in various forms including but not limited to standard (e.g. granulated) table sugar, powdered sugar, caster sugar, icing sugar, sugar syrup, silk sugar, unrefined sugar, raw sugar cane, molasses. Advantageously, the sweetener composition comprises silk sugar, such as the silk sugar manufactured by British Sugar Plc. Silk sugar is an ultrafine sugar preferably having a D90 particle size of less than 30 μm, or less than 25 μm, or 20 μm or less. Silk sugar may have a D50 particle size of less than 15 μm, or less than 10 μm, or less than 9 μm, or 8 μm or less. More preferably, silk sugar has a D90 particle size of 20 μm and a D50 particle size of 8 μm.

Advantageously, the sweetener composition consists of or essentially consists of one or more bulking agents, preferably soluble fibre e.g. resistant dextrin, and one or more crystalline carbohydrates, preferably sucrose. Advantageously, the sweetener composition consists of or essentially consists of one bulking agent, preferably soluble fibre e.g. resistant dextrin, and one crystalline carbohydrate, preferably sucrose.

In one aspect of the present invention, the sweetener composition may have a D90 particle size, i.e. granulometry, of 150 microns or less. The D90 value is a common method of describing a particle size distribution. “D90” refers to the value of the maximum particle dimension (for example, the diameter for a generally spherical particle) where 90% of the volume of the particles in the sample have a maximum particle dimension below that value. In other words, in a cumulative distribution of the maximum particle dimension in a sample of particles, 90% of the distribution lies below the D90 value.

“Maximum dimension” or “maximum particle dimension” refers to the longest cross-sectional dimension of any particular particle, e.g. a carbohydrate crystal, a particle of bulking agent, or particle of the final sweetener composition.

The D90 value may be measured for example by a laser light diffraction/scattering particle size analyser as described further below. Other known measurement techniques for particle size may also be used depending on the nature of the sample. The D90 value of powders may conveniently be measured by digital image analysis (such as using a CAMSIZER XT® as sold by Retsh GmbH) while the D90 value of particles comprised within a fat continuous material such as chocolate may be measured by laser light scattering. Particle size may be measured using any known method using suitable equipment. One device that is commonly used is a Malvern Mastersizer 3000 as sold by Malvern Panalytical Ltd.

For context, regular crystalline sugar (i.e. table sugar) has a D90 particle size of approximately 1000 microns. Icing sugar has a D90 particle size of approximately 150 microns. Refined sugar used in chocolate making typically has a D90 particle size of approximately, 30 microns. Silk sugar has a D90 particle size of less than 30 microns, or less than 25 microns, or less than 20 microns, or preferably less than 20 microns.

The sweetener composition may have a D90 particle size of 150 microns or less. Advantageously, the D90 particle size is 125 microns or less, or 100 microns or less, or 75 microns or less, or 50 microns, or 40 microns or less, or 30 microns or less, or 20 microns or less, or 10 microns or less. Preferably, the particle size of the sweetener composition is approximately the same as that of silk sugar. The lower limit of the particle size is greater than zero, but may be negligible depending on the limit of detection of the equipment used to measure the particle size.

Without wishing to be bound by theory, the relatively small particle size of the sweetener composition of the present invention (as indicated by the D90 value) means that it can dissolve more quickly in the oral cavity than sugar. This rapid dissolution leads to an enhanced perception of sweetness because it means that more of the sweetener composition is tasted by the tongue before being swallowed. Thus, the sweetener composition can be used to boost the sweetness of a food product when used as a sugar replacer. This effect unexpectedly counteracts any reduction in sweetness that may be expected due to the presence of bulking agents in the sweetener composition. The relatively small particle size also provides good mouthfeel to the final product as the composition will not be perceived as gritty or grainy in texture.

The sweetener composition is preferably in the form of a “dry” or “semi-dry” free flowing powder having a water content of 5 wt % or less, or 1 wt % or less, or 0.5 wt % or less.

The carbohydrate(s) and bulking agent(s) respectively may be present in the sweetener composition in an amount by weight according to the ratio of carbohydrate(s):bulking agent(s) of 99:1, or 98:2, or 97:3, or 96:4, or 95:5, or 90:10, or 85:15, or 80:20, or 75:25, or 70:30, or 65:35, or 60:30, or 55:45, or 50:50, or 45:55, or 40:60, or 35:65, or 30:60, or 25:75, or 20:80, or 15:85, or 10:90, or 5:95, or 4:96, or 3:97, or 2:98, or 1:99. The carbohydrate(s) and bulking agent(s) may also be present in the sweetener composition in an amount by weight within a range formed by a combination of the end points from any two of the above list of ratios.

The carbohydrate(s) may be present in the sweetener composition in an amount of 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight. The carbohydrate(s) may also be present in the sweetener composition in an amount by weight within a range formed by a combination of any two values from the above list of percentages. Preferably, the crystalline carbohydrate is present in the sweetener composition in an amount sufficient to provide the desired sweetness to the relevant food product.

The bulking agent(s) may be present in the sweetener composition in an amount of 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight. The bulking agent(s) may also be present in the sweetener composition in an amount by weight within a range formed by a combination of any two values from the above list of percentages.

Where soluble fibre is used as the bulking agent(s), it should be used in an amount which does not significantly hinder the crystallization (nucleation and/or crystal growth) of the carbohydrate used. For example, the amount of soluble fibre in the sweetener composition is less than 50%, or 40%, or 30%, or 20%, or 10%, or 5% by weight.

The sweetener composition may also comprise additional ingredients i.e. additives. For example, the composition may comprise an anti-caking or free flowing agent including but not limited to a silica based agent, calcium stearate, magnesium stearate, and/or extra dry starch. Other additives may include flavouring agents, colourants, masking agents, and/or technical aids (substances used to facilitate processing).

Advantageously, the sweetener composition of the present invention does not comprise any surface active agents, i.e. “surfactants”. The term surfactant is used herein to refer to a compound that lowers the surface tension or interfacial tension between particles. Surfactants may also act as detergents, wetting agents, emulsifiers, foaming agents and/or dispersants. The use of surfactants can be undesirable if they are of a type that is required by law to be listed on food labels as consumers are increasingly demanding “clean-label” food products.

The particles that make up the sweetener composition of the present invention are preferably non-porous, meaning that they are not hollow. The sweetener composition may consist, or essentially consist, of non-porous particles. The use of porous particles is disadvantageous where a sweetener composition is to be used in a food product that comprises fat because the fat will be at least partially absorbed into the hollow space inside the particles. This can cause the food product to have a higher relative fat content. By contrast, the use of non-porous particles in the sweetener composition of the present invention enables the production of relatively low fat food products which may be more desirable to health conscious consumers.

It has also been surprisingly found that sweetness is correlated with the off-taste. Essentially, it is possible to predict the sweetness of a given sweetener composition having a specific off-taste and vice versa.

### Process for the Preparation of the Sweetener Composition

Also provided is a process for preparing a sweetener composition in accordance with the present invention. The process comprises obtaining a solution of one or more carbohydrate(s) dissolved in a solvent. Preferably, the solution is saturated with the one or more carbohydrates. Alternatively or additionally, the process may comprise a step of forming a solution saturated with the one or more carbohydrates.

As used herein, the term “solvent” is used to refer to any food-grade liquid substance in which a carbohydrate solute can be dissolved. Advantageously, the solvent is water, pure water or mainly water.

As used herein, the term “solution” is used to refer to any food-grade liquid substance in which a carbohydrate solute is dissolved at a concentration of form 0.01 wt % up to 99.99 wt %, preferably 0.1 wt % up to 99.9 wt %, more preferably from 1.0 wt % up to 99 wt %. Advantageously, the solvent is water, pure water or mainly water.

A “saturated solution”, is a solution containing the maximum concentration of solute dissolved in the solvent under given conditions (e.g. temperature and pressure etc.). The “saturation point” is the concentration at which no more of the solute can be dissolved in the solution at the given conditions. Above this point, more solute will not dissolve and/or adding more solute may cause dissolved solute to precipitate, unless the solubility conditions are changed. Thus, a solution saturated with one or more carbohydrates is a solution in which no more carbohydrates will dissolve under given conditions.

A solution saturated with one or more carbohydrate(s) according to the present invention may be formed by dissolving the carbohydrate(s) in a solvent (e.g. water) at a constant temperature. Alternatively, the saturated solution may be formed by concentrating a diluted solution of carbohydrate(s) e.g. through evaporation or under a vacuum, or by cooling the solution after dissolving the carbohydrate(s), or both. The latter method may be advantageous to avoid undesirable reactions such as colour change. Commercially available carbohydrate (saturated) solutions may also be used. Advantageously, the saturated solution will contain a minimal amount of solvent so thereby reducing the amount of time required for drying in any subsequent (optional) drying step later in the process.

Where the process includes a step of forming a solution saturated with the one or more carbohydrates, this may be carried out at any stage of the process, but is preferably carried out before or simultaneously with combining the bulking agent(s) with the carbohydrate(s).

The bulking agent(s) may be combined with the (saturated) solution of carbohydrate(s) in numerous different ways. In one non-limiting example, the bulking agents may be prepared as solid fibres which are added to the solution and mixed to form a suspension or a paste. In another alternative non-limiting example, the bulking agent may be optionally premixed with one or more crystalline carbohydrate(s). In an alternative non-limiting example, the fibres may be prepared as a solution or suspension in a solvent and then mixed with the solution of carbohydrate(s). In the latter example, the amount of liquid (e.g. water) in the bulking agent solution/suspension is preferably minimal so that there is less liquid to remove in any drying step (optional) later in the process. In a further non-limiting example, the solution may be sprayed or pulverized onto the bulking agent fibres. For example, solid bulking agent fibres may be fluidized, e.g. in a fluidized bed dryer, and the carbohydrate solution may then be introduced in the form of droplets and pulverized onto the fibre. Other methods of combining the carbohydrate solution and the bulking agent(s) that are known to the person skilled in the art may also be used in accordance with the process of the present invention. Preferably, combining does not include dry blending.

The process of the present invention also comprises adjusting the temperature and/or concentration and/or solubility conditions of the carbohydrate solution and/or mixture such that crystallization of the carbohydrate occurs and a crystalline sweetener composition is obtained.

“Crystallization”, i.e. the formation of crystals, occurs in two major steps. The first step is nucleation, which is the formation of small solid particles (i.e. crystals) in a solution. Nucleation is influenced inter alia by the temperature and concentration of the solution. Nucleation may be assisted by adding a “seed”, or it may be unseeded. The second step is crystal growth, which is where the particles formed in the nucleation step increase in size. Growth rate is influenced by several factors, including but not limited to the surface tension of the solution, pressure, temperature, and relative crystal velocity in the solution. As used herein, the term “crystallization” may refer to nucleation and/or crystal growth.

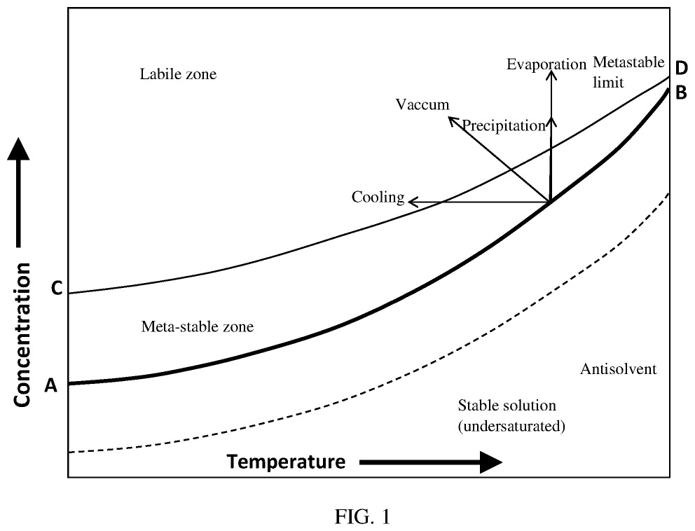

Crystallization is driven by the formation of a “supersaturated solution”, which is a solution that contains more dissolved solute than could be dissolved by the given solvent underdefined conditions of temperature and pressure, i.e. more than a saturated solution. The phase diagram of a given solute (for instance a sugar) in a given solvent (for instance water, including water mixed with an antisolvent) is illustrated in FIG. 1.

The line A-B in FIG. 1 shows the saturation point of a solute in a solvent at different temperatures. The solubility curve depends on the specific carbohydrate and solvent being used. A person skilled in the art would have no difficulty in preparing a solubility curve as required using routine experimental methods and/or through using reference solubility values from the available literature. For most carbohydrates, the solubility increases with increasing temperature. The region below the line A-B represents stable solutions. Any solute added to a solution in this region will dissolve. If conditions are manipulated, a stable solution can become supersaturated and unstable, triggering crystal growth. Cooling is the simplest example of this. If a stable solution is cooled, it will enter into the meta-stable region between line A-B and line C-D. In this region, any existing crystals in the solution will grow, but no new crystals will form. Cooling the solution further will lead to an unstable or “labile” zone, represented by the region above and including the line C-D. In a labile solution spontaneous formation of new crystals, i.e. nucleation, occurs. The formation of crystals in turn leads to a reduction in concentration, so if cooling continues the solution will either stay in the labile region or enter once again into the meta-stable region where the crystals can grow.

As shown in FIG. 1, a stable solution can be moved to the labile region by means other than cooling. The concentration can be manipulated or adjusted, for example by evaporation and/or by applying a vacuum. Solubility characteristics may also be manipulated or adjusted, for example by adding a second solvent (commonly known as an “antisolvent”) in which the solute is less soluble than in the original solvent. One or more of these and other adjustment methods may be applied at the same time.

The inventors have taken advantage of the above scientific principles, normally applied in other fields, to prepare a crystalline sweetener composition. The process involves adjusting the temperature and/or concentration and/or solubility conditions of the carbohydrate solution and/or mixture such that the carbohydrate solution becomes supersaturated and enters the labile zone, so that crystallization (nucleation and/or crystal growth) of the carbohydrate occurs.

According to the process of the invention, crystallization may be terminated once sufficient crystallization has occurred. By this it is meant that enough crystals of the desired particle size (e.g. D90 of 150 microns or less) have formed and the composition is sufficiently pure for the relevant application. For example sufficient crystallization may have been achieved and the process terminated once at least 50%, or at least 55%, or at least 60%, or at least 65%, or at least 70%, or at least 75%, or at least 80%, or at least 85%, or at least 90%, or at least 95%, or at least 96%, or at least 97%, or at least 98%, or at least 99%, or at least 99.5% of the carbohydrate has crystalized. The amount of time required for sufficient crystallization to occur will depend on the specific carbohydrate(s), bulking agent(s) and solvent(s) being used and may be determined through routine testing.

The adjustment of the solubility conditions and crystallization step may preferably be carried out after the carbohydrate solution has been combined with the bulking agent(s) or at the same time (i.e. simultaneously).

In a non-limiting example of the process of the invention, the process may involve obtaining a relatively hot solution, preferably saturated, of one or more carbohydrate(s) and combining this with a relatively cold preparation of bulking agent(s). In this example, the solution is prepared at, and/or heated to, a first temperature that is above ambient temperature, but below the boiling point of the solvent. Within this range, the preferred first temperature is close to the boiling point so that the maximum amount of solute may be dissolved with the minimum amount of solvent. This minimises the amount of time required for drying in any subsequent (optional) drying step of the process because there is less solvent to be evaporated. Where the solvent used is (distilled, pure) water, non-limiting examples for the first temperature are at least 30, at least 40, at least 50, at least 60, at least 70, at least 80, at least 90, at least 95, at least 99, or 99.5 degrees Celsius. Higher temperatures may be required for dissolution of certain carbohydrates and/or for solvents other than water. The bulking agent(s) may be prepared at, and/or heated to, a second temperature that is below the first temperature (and below ambient temperature). Where the bulking agent(s) is in a solution or suspension, the second temperature will be above the freezing point of the solvent. Within this range, the second temperature is advantageously at least 10, at least 20, at least 30, at least 40, at least 50, at least 60, at least 70, at least 80, at least 90, at least 100, or more than 100 degrees less than the first temperature.

The relatively cold bulking agent(s) is then added to the relatively hot carbohydrate solution causing thermal shock (i.e. massive cooling) that triggers massive nucleation of carbohydrate crystals. In this way, the temperature of the mixture is adjusted simultaneously with combining the bulking agent(s) and the solution. The bulking agent(s) are preferably added to the carbohydrate solution whilst mixing, for example in a double screw mixer, or a rotating pan. The crystalizing mixture will have an intermediate temperature that is between the first temperature and the second temperature. The optimum intermediate temperature will depend on several factors, such as the quantity and type of bulking agent and carbohydrate used. A person skilled in the art would have no difficulty determining the optimum intermediate temperature through routine experimentation, e.g. trial and error, to assess levels of crystallization at different conditions or via calculations based on characteristics available in the literature. The lower the intermediate temperature, the higher the supersaturation level will be, and the higher the level of nucleation will be.

Cooling may be continued below the intermediate temperature to promote crystal growth by operating in the metastable zone if larger crystals are desired, or by operating in the labile zone if the objective is to produce additional finer crystals. The resulting crystalline sweetener composition may optionally be centrifuged to remove the excess of non-crystallized syrup (known to persons skilled in the art as “greens”). Thereafter, the remaining material containing the crystals is dried to form a powder.

In another, non-limiting example of the process of the invention, the bulking agent(s) is a solid which is fluidized in a fluidized bed dryer. The, preferably saturated, carbohydrate solution is then introduced into the dryer in the form of fine droplets, which are pulverized onto the bulking agent(s). The pulverisation can be done either continuously or discontinuously depending on how fast the crystallization occurs. The dryer is set to an appropriate vacuum and temperature so that the solvent in the droplets is evaporated and crystal formation and/or growth can take place. Without wishing to be bound by theory, the progressive evaporation of the solvent in the droplets causes an increase in the local concentration of the carbohydrates above the saturation point. As a result, the solution becomes labile and the carbohydrate molecules will undergo crystallization. An advantage of this exemplary process is that all the steps of the method may be carried out using a single piece of equipment (fluidized bed dryer) thereby reducing manufacturing time and costs.

In a further non-limiting example of the process of the invention, a suspension containing the, preferably saturated, carbohydrate solution and the bulking agent(s) is concentrated under vacuum by evaporation in a vacuum pan. Without wishing to be bound by theory, when the concentration of the carbohydrate sufficiently exceeds the saturation point of the carbohydrate, spontaneous formation of crystals will take place.

In general, a “seed” may be added to the mixture before or during the crystallization step in order to promote or enhance the crystallization process, as described earlier. Preferably, the seed will be carbohydrate, especially a size reduced or very fine (e.g. similar granulometry to silk sugar) carbohydrate. Preferably, the seed should have the same chemical nature as the carbohydrate to be crystallized. More preferably, the seed is the same carbohydrate as the one to be crystallized. A person skilled in the art would know how to select a suitable seed and to add this seed in a manner that allows it to disperse without dissolving. Furthermore, the skilled person would know how to estimate the amount of seed and the granulometry of the seed needed to reach the desired final crystal size. The crystallization process may also be encouraged by carrying out the crystallization process whilst agitating the solution and/or mixture for example using high shear mixing, ultrasound, and/or a vacuum. High shear mixing may include the incorporation of air and/or gas. High shear is defined herein as at least 1000 rpm, preferably 6000-10000 rpm.

In general, the sweetener composition obtained via any of the above non-limiting examples may be further processed. Further processing may include for example separating the crystals from the greens (i.e. by-products), and/or drying the sweetener composition to form a powder, and/or cooling the dried powder to reduce the stickiness of the material, and/or milling the dried sweetener composition to reduce the particle size.

Preferably, drying is carried out simultaneously to and/or after crystallization. As used herein, the term “drying” means reducing the amount of solvent in the sweetener composition. Drying may be carried using any method known in the art. For example, drying may be carried out using a dryer such as a fluidized bed dryer, centrifugation, evaporation and/or vacuum treatment. The Drymeister® Flash dryer sold by Hosokawa Micron Powder Systems is one example of a dryer that may be used in the process of the present invention.

Advantageously the sweetener composition is dried to form a “dry” or “semi-dry” free flowing powder having a water content of 5 wt % or less, or 1 wt % or less, or 0.5 wt % or less.

Simultaneous crystallization and drying or crystallisation followed by drying can be carried out with a variety of different equipment. Non-limiting examples are provided below.

With one type of fluidized bed, e.g. GLATT fluidized bed, first bulking agent and a small amount of crystalline carbohydrate acting as a seed are mixed together. The mixture is slightly moistened with water to enable fluidization of the mixture. The bulking agent and carbohydrate mixture is fluidized on the powder bed whilst a carbohydrate solution is sprayed onto the fluidized mixture. The hot air used for the fluidization of the powder ensures the evaporation of the water in the carbohydrate solution and consequently pushes the carbohydrate in the supersaturation state. This level of concentration pushes the carbohydrate molecules to either grow existing crystals/pieces of crystals (crystal growth) or form new fine crystals (nucleation). The quantity of water removed by the hot air and the one present in the carbohydrate solution is fine-tuned to maintain the carbohydrate solution in a supersaturated state. A lot of air is circulated during the process around the particles. Crystallisation and drying occurs simultaneously. The dried granules are then milled to a D90 of less than 50 microns.

With another type of fluidized bed, e.g. RETSCH fluidized bed, first bulking agent and all of the carbohydrate are mixed together. Water is then sprayed on the mixture to form granules and to dissolve a layer of carbohydrate found at the surface. The dissolved carbohydrate, without being bound by theory, forces the bulking agent and the non-dissolved carbohydrate to adhere together, which is the same principle as in wet granulation. The obtained wet granules are then dried in a stream of hot air. The non-dissolved carbohydrate act as a seed for the crystallisation of the dissolved carbohydrate. The air stream ensures the increase of the concentration of the dissolved carbohydrate above saturation and consequently pushes the dissolved carbohydrate either to grow existing crystals/pieces of crystals (crystal growth) or form new fine crystals (nucleation). Granules are then dried and finally milled to a D90 of less than 50 microns.

With yet another type of equipment, e.g. an AVA type reactor/dryer, first bulking agent and a small amount of carbohydrate acting as a seed (two different seeding amounts were tested with each bulking agent) are mixed together in the reactor/dryer. Vacuum is applied to enable water evaporation at low temperatures. The carbohydrate solution is sprayed on the powder bed. Meanwhile supersaturation is maintained, so that crystallisation is ensured. Crystallisation and drying occurs simultaneously. The dried granules are then milled to a D90 of less than 50 microns.

Using the process of the present invention, a sweetener composition can be obtained that has a very fine particle size (D90 of 150 microns or less). As described elsewhere in the present description this leads to enhanced sweetness perception and a good mouthfeel. This is in part because the crystallization step can be tightly controlled to produce crystals having the desired particle size. In addition, the crystalline sweetener composition has good stability because the bulking agent(s) will be structurally embedded and/or homogeneously distributed in the material of the fine crystals of the carbohydrate.

The carbohydrate(s) and bulking agent(s) that are combined in accordance with the present invention may have a D90 particle size of 150 microns or less to result in a sweetener composition having this desired particle size. Advantageously, the D90 particle size of the carbohydrate(s) and bulking agent(s) is 125 microns or less, or 100 microns or less, or 75 microns or less, or 50 microns or 40 microns or less or 30 microns or less 20 microns or less. The lower limit of the particle size is greater than zero, but may be negligible depending on the limit of detection of the equipment used to measure the particle size.

The carbohydrate(s) and bulking agent(s) that are combined may already be size reduced particles, meaning that they have been subjected to a particle size reduction technique to achieve the desired particle size before combining.

Alternatively or additionally, the process of the invention may further comprise subjecting the carbohydrate(s) and/or the bulking agent(s) and/or the final crystalline sweetener composition to a particle size reduction technique to achieve the desired particle size for the sweetener composition. Any particle size reduction technique that is known in the art may be used in accordance with the present invention, such as milling, micronization, grinding, extrusion, high pressure homogenization, abrasion, fractionation, or pulverizing. A combination of particle size reduction techniques may also be used.

A “size reduced” particle (e.g. of carbohydrate) is a particle which has a smaller D90 particle size than the naturally occurring form of that particle as a result of having been subjected to a size reduction technique.

Any known milling method may be used in accordance with the present invention. For example, ball-milling, wet-ball milling, or micro-milling in an impact mill.

Micronization may be used to provide very fine particles (e.g. less than 100 microns). Micronization methods are known in the industry. For example WO2017/167965, which is incorporated herein by reference, describes a micronized “bran-like” material. Micronization involves heat-treating the material and then milling at high speed (e.g. at least 3000 rpm) using a high performance mill, such as a cell mill or jet mill.

A cell mill is a highly efficient mechanical mill with multiple rotors mounted on a vertical shaft. Product quality is optimised by control of mill speed through a frequency inverter, which also limits the starting current. A cell mill results in two product streams, standard (or product) and oversize, the standard stream is the preferred output that may comprise micronized bran of the invention.

A jet mill (also known as a microniser) typically comprises a spiral jet which uses compressed gas to produce superfine materials by autogenous comminution. Feed material is inspirated by a small proportion of the compressed gas through a venturi into the grinding chamber where numerous angles nozzles accelerate the material into particle-particle impact. There are no moving parts in the mill and no mechanical forces are applied to the grinding process. Variation in gas pressure and residence time is possible.

Non-limiting examples of suitable milling equipment for use in the process of the present invention are the Micro Pulverizer®, SugarPlex 315 SX®, or Mikro ACM® Air Classifying Mill models sold by Hosokawa Micron Powder Systems.

The particle size reduction technique may be cryogenic. Cryogenic techniques are particularly useful where there is a need to control or reduce the stickiness of the particles.

The particle size reduction technique may be carried out at any stage in the process of the invention, but is preferably carried out on the carbohydrate(s) and/or bulking agent(s) before they are combined, or at the same time as combining them. Particle size reduction may alternatively or additionally be carried during or after drying the sweetener composition.

The particle size reduction technique may also include size classification and/or separation steps (e.g. sieving or sifting). For example a TTC/TTD Air Classifier® or Mikro® Acucut Air classifier model sold by Hosokawa Micron Powder Systems may be used.

As described above, additional ingredients may be added to the sweetener composition of the invention. These may be added at any time during the preparation process, including adding them to the starting materials before combining, adding them during the combining or crystallization steps, or adding them to the crystalline sweetener composition before or after drying (i.e. blending with the final sweetener composition). The additives are preferably added under mixing, for example using a ribbon mixer, conical screw mixer, or silo mixer.

Any or all (e.g. two or more) of the process steps of: obtaining a solution of carbohydrate(s), optionally forming a solution saturated with carbohydrate(s), combining the solution with bulking agent(s), adjusting the temperature/concentration/solubility conditions, optionally drying the sweetener composition, optionally carrying out size reduction, and/or optionally adding further ingredients may occur simultaneously, sequentially, or non-sequentially. For example, all of these steps may be carried out simultaneously using a dryer, such as a fluidized bed dryer. One or more of the steps may be repeated. For example, the temperature/concentration/solubility of the solution may be adjusted prior to combining the carbohydrate solution with the bulking agent(s) in order to form a solution saturated with the carbohydrate(s) and/or to initiate the crystallization process, and subsequently the temperature/concentration/solubility of the mixture of the carbohydrate(s) and bulking agent(s) may be adjusted further to cause (further) crystallization.

### Uses

The sweetener composition of the present invention may be used in the manufacture of a food product. In particular, it may be used to wholly or partially replace the sugar in a recipe for a food product (i.e. it may be used as a “sugar replacer”). The term “replace” is not intended to be construed such that sugar must be removed from a food product before adding the sweetener composition of the invention, rather it is meant that the sweetener composition is used instead of all or part of the sugar that would otherwise be used when manufacturing the food product. When used as a sugar replacer, the sweetener composition may be used to replace up to 10%, or up to 20%, or up to 30%, or up to 40%, or up to 50%, or up to 60%, or up to 70%, or up to 80%, or up to 90%, or up to 100% of the sugar in the food product by weight. The sweetener composition may be present in the food product in an amount by weight within a range formed by a combination of any two values from the above list of percentages. Advantageously, the present invention provides replacement of sugar in a food product whilst still achieving the comparable levels of sweetness, similar levels of sweetness, or enhanced levels of sweetness and preferably still maintaining similar texture and mouthfeel of sugar.

The food product may be a confectionary product, a culinary product, a dairy product, a nutritional formula, a breakfast cereal (including flapjacks, cereal bars, and extruded cereal based products and co-extruded filled cereal based products), a baked product, and/or animal food. Confectionary products are foodstuffs which are predominately sweet in flavour and are not predominately baked. Exemplary confectionary products include, but are not limited to, fat-based confectionary products, such as chocolate, chocolate-like material, fat-continuous filling material and frozen confectionary, such as ice cream and combinations thereof, for instance chocolate coating of frozen confectionary or chocolate pieces within frozen confectionary. Further examples of confectionary products include, but are not limited to, non-fat-based confectionary products, sweets, candies, gummies, sugar confections, tablets, treats, toffees, boiled sweets, bonbons, candy-floss, caramel, fudge, liquorice, marshmallow, nougat, truffle, fondant, ganache etc. Baked products are, or comprise components which are, predominately baked and may be sweet or savoury and may comprise baked grain foodstuffs. Exemplary baked products can comprise baked cereals and/or pulses such as baked wheat foodstuffs, such as bread, rolls, cakes, pastries, crumpets, scones, pancakes, pies, gingerbreads, biscuits, wafers, and/or cookies etc. The food product according to the present invention may be the entire food product or it may part of a food product such as a filling, binder, a shell or coating, inclusion or decoration for a food product. The food product may also be a multi-layered foodstuff optionally comprising a plurality of layers of baked foodstuff, wafer or biscuit and at least one filling layer located between the layers of baked foodstuff, wafer or biscuit the filling layer comprising a fat based confectionery composition. Any combination of the above alternatives is also encompassed by the present invention. Advantageously, the food product has a relatively low water content, such as 5 wt % or less, or 4 wt % or less, or 3 wt % or less, or 2 wt % or less, or 1 wt % or less.

The term “chocolate” is used herein to mean any product (and/or component thereof) that meets a legal definition of chocolate in any jurisdiction (preferably the US and/or EU) and also includes any product (and/or component thereof) in which all or part of the cocoa butter is replaced by cocoa butter equivalents/replacers/or substitutes. The chocolate may be of a dark, milk, or white variety. The term “chocolate-like material” is used herein to mean chocolate-like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids and/or compounds that comprise cocoa butter, cocoa butter equivalents, cocoa butter replacers and/or cocoa butter substitutes.

### Materials and Methods

### Measuring D90 Particle Size

The particle size distribution of a sample may be measured by laser light diffraction, for example using a Mastersizer 3000 system (Malvern). This equipment allows the measurement of particles with sizes ranging from 0.1-3500 microns. The system includes a:
Helium Neon red laser (633 nm, max 4 mW) along with a 10 mW 470 nm blue LED light source and a wide angle detection system (0.015-144 degrees).
Hydro MV medium volume automated liquid sample dispersion unit or Hydro SM manual liquid sample dispersion unit for measurements in liquid (Oil, solvents, water)
Aero S automated dry powder dispersion system with a venturi disperser.

Prior to sample measurement a background measurement (duration 10 s or longer) may be carried out.

Preferred settings for measurements:
Particle type: non-spherical
Particle optical parameters: Refractive index (RI) and Absorption index (AI) of the sample.
Calculation: Mie theory
Optical parameters of background medium: Refractive index (RI) Absorption index (AI) of the medium: Air for powder measurement, dispersant for measurements in liquid.

As mentioned earlier, the machine is equipped with two different modules enabling the measurement of particles size distribution in dry or dispersed in liquid. The choice of the method (dispersion in air or in liquid) depends on the particles' capability to disperse in air or in a liquid. The choice of the dispersion media should not affect the size and/or the shape of the particles. In the present invention the dispersion mediums used are air in the case of the Aero S module and oil in the case of the Hydro SM module.

Preferred settings of the measurement with the Aero S module:
Feed rate: 0-100% (optimized to obtain obscuration range 0.5-15%)
Air pressure: 0-3 bar
Obscuration: range 0.5-15%
Amount of sample: 1-20 g of sample is added to the venturi dispenser
Measurement duration: time needed to measure the whole sample that was added to the venturi dispenser

Settings of the measurement with the Hydro SM module:
Obscuration: range 2-20%—Sample is added to the liquid sample dispersion unit until the obscuration is in range (See table 1)
Stirring speed: 1000-3000 rpm
Measurement duration: 10 s or longer

TABLE 1
Obscuration settings for Mastersizer 3000 system

| SIZE | OBSCURATION |
|---|---|
| very fine (<1 μm) | <5% |
| fine (1-100 μm) | 5-10% |
| coarse (1000 μm) | 10-20% |
| very polydisperse (>1000 μm) | 10-20% |

The volumetric particles size distribution is calculated from the intensity profile of the scattered light with the Mie theory by use of the software accompanying the machine. The following parameters, among others, are automatically generated by the software:
D [v,0.1]: is the volume diameter where 10% of the volume distribution is below this value (D [v,0.1]).
D [v,0.5]: is the volume median diameter where 50% of the volume distribution of the particles is above and 50% is below this value (D [v,0.5]).
D [v,0.9]: is the volume diameter where 90% of the volume distribution is below this value (D [v,0.9]). This is the D90 particle size in accordance with the present invention.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

Representative features are set out in the following clauses, which stand alone or may be combined, in any combination, with one or more features disclosed in the text and/or drawings of the specification.

A process for preparing a sweetener composition comprising one or more crystalline carbohydrate(s), the process comprising:
obtaining a solution of one or more carbohydrate(s) dissolved in a solvent, and
combining the solution with one or more bulking agent(s) and optionally one or more crystalline carbohydrate(s), and
adjusting the temperature and/or concentration and/or solubility conditions of the solution and/or mixture such that crystallization of the carbohydrate occurs and a sweetener composition comprising one or more crystalline carbohydrate(s) is obtained.

A process according to clause 1, wherein the solution obtained is saturated with at least one of the one or more carbohydrate(s), and/or wherein the process further comprises a step of forming a solution saturated with at least one of the one or more carbohydrate(s).

A process according to clause 1 or 2, further comprising a step of drying the sweetener composition.

A process according to any preceding clause, wherein any two or more of the steps of the process occur simultaneously, sequentially, or non-sequentially.

A process according to any one of the preceding clauses, wherein the temperature is adjusted by cooling the mixture, and/or the concentration is adjusted by evaporating and/or applying a vacuum to the mixture, and/or wherein the solubility is adjusted by adding an antisolvent.

A process or sweetener composition according to any one of the preceding clauses, wherein the carbohydrate is selected from the group consisting of monosaccharides, disaccharides, polyols, and any combination thereof.

A process or sweetener composition according to any one of the preceding clauses, wherein the carbohydrate is sucrose.

A process according to any one of the preceding clauses, wherein the carbohydrate solution has a first temperature and the bulking agents(s) has a second temperature that is lower than the first temperature such that the mixture obtained by combining the carbohydrate solution with the one or more bulking agent(s) has an intermediate temperature, wherein the intermediate temperature is such that crystallization occurs.

A process according to any one of the preceding clauses, wherein one or more of the process steps are carried out using a dryer, optionally a fluidized bed dryer, dryer mixer, dryer blender.

A process according to any one of the preceding clauses, wherein combining involves forming a suspension.

A process according to any one of the preceding clauses, wherein the sweetener composition has a D90 particle size of 150 microns or less.

A process according to any one of the preceding clauses wherein at least 50% of the carbohydrate in the sweetener composition is in crystalline form.

A sweetener composition obtained or obtainable by the process of any of the preceding clauses.

A food product comprising the sweetener composition of clause 13.

A process according to any one of the preceding clauses further comprising a cooling step after the sweetener composition is obtained.

A process according to any one of the preceding clauses further comprising adding a seed to the solution and/or mixture to promote crystallization.

A process according to any one of the preceding clauses further comprising agitating the solution and/or mixture to promote crystallization.

A process according to any one of the preceding clauses, wherein the solvent is water.

A process according to any one of the preceding clauses, further comprising subjecting the carbohydrate(s) and/or bulking agent(s) and/or sweetener composition to a particle size reduction technique, optionally wherein the particle size reduction technique is milling and/or micronization and/or milling-classification.

A process or sweetener composition according to any one of the preceding clauses, wherein the bulking agent comprises insoluble and/or soluble fibre.

A process or sweetener composition according to clause 20, wherein the insoluble fibre is selected from the group consisting of dietary fibre, cereal bran, oat fibre, bamboo fibre, fruit fibre, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose, chitosan, pectins, gums, mucilages, lignins, micronized versions of the same, compositions comprising the same or combinations thereof.

A process or sweetener composition according to clause 20 or 21 wherein the soluble fibre is selected from the group consisting of resistant dextrin, resistant/modified maltodextrin, polydextrose, β-glucan, galactomannan, fructo-oligosaccharides, gluco-oligosaccharide, galacto-oligosaccharides, MOS (mannose-oligosaccharides), pectin, psyllium, inulin, resistant starch, compositions comprising the same or combinations thereof.

A process or sweetener composition according to any preceding clause wherein the amount of soluble fibre in the sweetener composition is less than 50%, or 40%, or 30%, or 20%, or 10%, or 5% by weight.

A process according to any one of the preceding clauses, further comprising adding an additive.

A process according to clause 24, wherein the additive is an anti-caking agent.

A process or sweetener composition according to any preceding clause, wherein the sweetener composition does not comprise a surface active agent.

A process or sweetener composition according to any preceding clause, wherein the sweetener composition consists essentially of non-porous particles.

A process or sweetener composition according to any preceding clause, wherein the sweetener composition consists of or essentially consists of one or more bulking agents, preferably a soluble fibre, more preferably resistant dextrin, and one or more crystalline carbohydrates, preferably sucrose.

A process or sweetener composition according to any preceding clause, wherein the sweetener composition consists of or essentially consists of one bulking agent, preferably a soluble fibre, more preferably resistant dextrin, and one or more crystalline carbohydrates, preferably sucrose.

A process for reducing the hygroscopicity or the stickiness of resistant dextrin comprising the process according to any one of the previous clauses, wherein the bulking agent comprises resistant dextrin.

A process for predicting the sweetness of a sweetener composition based on the known off-taste of a bulking agent or a process for predicting the off-taste of a sweetener composition based on the known sweetness of a bulking agent.

### Examples

### 1. Preparation of the Bulking Agents

Various Samples of Bulking Agents were Prepared for Use According to the Invention.

| | |
|---|---|
| Resistant dextrin made | A resistant dextrin syrup was spray dried to |
| with spray drying (RD) | directly obtain a powder having a D90 of less |
| | than 100 microns |
| Micronized Exhausted | Obtainable from Prova SAS, France, and |
| cocoa powder (ECP) | milled to get a D90 below 40 microns using a |
| | pin mill from Jehmlich |
| Micronized Wheat | Wheat bran was micronized to obtain a D90 |
| Bran (MWB) | below 40 microns using a Hosokawa Jet mill |
| Micronized Cocoa | Obtainable from GreenField, Poland as |
| shells (MCS) | “Cocoa fiber M20” which had a D90 below 40 |
| | microns |
| Micronized corn bran | Corn bran obtained from Limagrain |
| (MCB) | Ingredients was micronized to obtain a D90 |
| | below 40 microns using a Hosokawa Jet mill |
| Microcrystalline | Vivapur ® 105 obtainable from Rettenmaier. It |
| cellulose (MCC) | had a D90 of below 40 microns. |

### 2. Preparation of the Sweetener Compositions

The above bulking agents were then mixed together with silk sugar (an ultrafine crystalline milled sucrose with a D50 of less than 8 microns) and then liquid sugar is sprayed and simultaneously concentrated to ensure sugar recrystallization. In parallel, the obtained mass is continuously mixed to enable a homogeneous distribution of the sugar to avoid the formation of lumps. One of the following three pieces of equipment was used for the purposes of these experiments:

A GLATT fluidized bed: first bulking agent and a small amount of silk sugar acting as a seed were mixed together. The mixture was slightly moistened with water to enable fluidization of the mixture. The bulking agent and silk sugar mixture was fluidized on the powder bed whilst a sucrose solution sprayed on the fluidized mixture. The hot air used for the fluidization of the powder ensured the evaporation of the water of the sugar solution and consequently pushed the sugar in the supersaturation state. This level of concentration pushed the sugar molecules to either grow existing crystals/pieces of crystals (crystal growth) or form new fine crystals (nucleation). The quantity of water removed by the hot air and the one supplied in the sugar solution was fine-tuned to maintain the sugar solution in a supersaturated state. A lot of air circulated during the process around the particles. Crystallisation and drying occurred simultaneously. The dried granules were then milled to a D90 of less than 50 microns.

A RETSCH fluidized bed: first bulking agent and all of the silk sugar were mixed together. Water was then sprayed on the mixture to form granules and to dissolve a layer of sugar found at the surface. The dissolved sugar, without being bound by theory, forced the bulking agent and the non-dissolved sugar to adhere together, which is the same principle as in wet granulation. The obtained wet granules were then dried in a stream of hot air. The non-dissolved sugar acted as a seed for the crystallisation of the dissolved sugar. The air stream ensured the increase of the concentration of the dissolved sugar above saturation and consequently pushed the dissolved sugar either to grow existing crystals/pieces of crystals (crystal growth) or form new fine crystals (nucleation). Granules were then dried and finally milled to a D90 of less than 50 microns.

An AVA reactor/dryer: first bulking agent and a small amount of silk sugar acting as a seed (two different seeding amounts were tested with each bulking agent) were mixed together in the reactor/dryer. Vacuum was applied to enable water evaporation at low temperatures. The carbohydrate solution was sprayed on the powder bed. Meanwhile supersaturation was maintained, so that crystallisation was ensured. Crystallisation and drying occurred simultaneously. The dried granules were then milled to a D90 of less than 50 microns.

The following sweetener compositions made of bulking agent and silk sugar were prepared using the equipment as stated:

Experiments were carried out to prepare sweetener compositions in a GLATT Fluidized bed:

| Sweetener | GLATT Fluidized Bed | | | | | |
|---|---|---|---|---|---|---|
| Composition | G1 | G2 | G3 | G4 | G5 | G6 |
| Bulking | RD | ECP | MWB | MCS | MCB | MCC |
| agent | | | | | | |
| Sugar/ | 50/50 | 50/50 | 50/50 | 50/50 | 50/50 | 50/50 |
| Bulking | | | | | | |
| agent wt | | | | | | |
| ratio | | | | | | |
| % seed | 40% | 10% | 10% | 10% | 10% | 10% |
| Type of seed | Silk | Silk | Silk | Silk | Silk | Silk |
| | sugar | sugar | sugar | sugar | sugar | sugar |
| Bulking | <100 μm | <40 μm | <40 μm | <40 μm | <40 μm | <40 μm |
| agent D90 | | | | | | |
| (μm) | | | | | | |
| Milling post | Yes | Yes | Yes | Yes | Yes | Yes |
| drying | | | | | | |

The conditions of the GLATT fluidized bed:

Conditions to prepare sweetener compositions comprising bulking agent + sucrose

| | Conditions to prepare sweetener compositions comprising bulking agent + sucrose | | |
|---|---|---|---|
| | | MCS, ECP, MWB, | or resistant |
| | Parameter | MCB or MCC | dextrin |
| Ingredients | Mass of sugar to be dissolved (g) | 111.375 | 86.625 |
| preparation | Mass of water used to dissolve the sugar (g) | 44.15 | 34.3 |
| | Type of bulking agent | MCS | Fiber A |
| | Mass of bulking agent (g) | 123.75 | 123.75 |
| | Mass of seed i.e. silk sugar (g) | 12.375 | 37.125 |
| Agglomeration | Equipment used | Mixer | Mixer |
| | Equipment brand | Kitchen Aid | Kitchen Aid |
| | Equipment model | Artisan | Artisan |
| Drying | Mass of sugar sprayed (g) | 111.375 | 86.625 |
| | Concentration of the sugar sprayed (% DS) | 73.7% | 73.7% |
| | Temperature of the sugar solution sprayed (° C.) | 70 | 70 |
| | Reference of the nozzels used for spraying the | Mini-Glatt; schlick- | Mini-Glatt; schlick- |
| | suga | Mod.951 S20, nozzle | Mod.951 S20, nozzle |
| | | body version 1.0, | body version 1.0, |
| | | D4.1074 | D4.1074 |
| | Air flow used for drying (m3/h) | 40-50 | 40 |
| | Temperature of the air used for drying (° C.) | 50-70 | 55-67 |
| | Approximate time before it reach ambient T | 20 | 20 |
| | (min) | | |
| Moisture of the | Method used | Infra red balance, | Infra red balance, |
| final product | | Temp: 105° C. | Temp: 105° C. |
| | Reference of the equipment | Satorius MA 150 | Satorius MA 150 |
| | Amount of moisture obtained (%) | 3.45 | 1.85 |
| Milling | Standard laboratory milling equipment | Retsch SR 300 | Retsch SR 300 |
| Granulometry | Dx90 (in microns) | <50 | <50 |
| measurment of | | | |
| Sweetener | | | |
| Composition | | | |

Experiments were also carried out to prepare sweetener compositions in a RETSCH Fluidized bed:

| Sweetener | RETSCH Fluidized Bed | | | | | |
|---|---|---|---|---|---|---|
| Composition | R1 | R2 | R3 | R4 | R5 | R6 |
| Bulking agent | RD | ECP | MWB | MCS | MCB | MCC |
| Sugar/ | 50/50 | 50/50 | 50/50 | 50/50 | 50/50 | 50/50 |
| Bulking agent | | | | | | |
| wt ratio | | | | | | |
| % seed | 50% | 50% | 50% | 50% | 50% | 50% |
| Type of seed | Silk | Silk | Silk | Silk | Silk | Silk |
| | sugar | sugar | sugar | sugar | sugar | sugar |
| Bulking agent | <100 μm | <40 μm | <40 μm | <40 μm | <40 μm | <40 μm |
| D90 (μm) | | | | | | |
| Milling post | Yes | Yes | Yes | Yes | Yes | Yes |
| drying | | | | | | |

The conditions of the RETSCH fluidized bed:

| Ingredient preparation | Resistant dextrin | MCP | MWB |
|---|---|---|---|
| Fiber moisture (%) | 4.4 | 4.5 | 3.8 |
| Fiber mass (g) | 261.5 | 261.6 | 259.9 |
| Sugar moisture (%) | 0.8 | 0.8 | 252.0 |
| Sugar mass (g) | 252.0 | 252.0 | 0.8 |
| Mixing and wetting in kitchen aid mixer | | | |
| Equipment model | Artisan | Artisan | Artisan |
| Mixing device | Kitchen Aid | Kitchen Aid | Kitchen Aid |
| Water added (g) | 29.2 | 177.2 | 67.2 |
| Final moisture of the granules after wetting (%) | 3.2 | 24.1 | 11.8 |
| Final mass of the granules after wetting (g) | 522.2 | 680.1 | 570.5 |
| Drying in Retsh fluidized bed | | | |
| Equipment model | RETSCH TG1 | RETSCH TG1 | RETSCH TG1 |
| Adjustment knob for heating output (scale 1-10) | 9.0 | 9.0 | 9.0 |
| Adjustment knob for blower output (scale 1-10) | 9.0 | 9.0 | 9.0 |
| Temperature controller (setpoint + actual scale 0- | 50.0 | 70.0 | 70.0 |
| 120° C.) | | | |
| Drying time (min) | 58.8 | 54.0 | 60.0 |
| Product temperature at the end of the drying (° C.) | 48.0 | 61.7 | 60.8 |
| Final product moisture at the end of the drying (%) | 1.8 | 1.7 | 1.4 |
| Cooling of the product | | | |
| Time required (min) | 30.0 | 30.0 | 40.0 |
| Final temperature (° C.) | 27.2 | 30.8 | 31.7 |
| Ambient temperature Dust room (° C.) | 27.2 | 30.5 | 30.0 |
| Milling using laboratory milling equipment | | | |
| Dx90 (microns) of sweetener composition | <50 | <50 | <50 |

| Ingredient preparation | MCB | MCS | ECP |
|---|---|---|---|
| Fiber moisture (%) | 4.7 | 2.6 | 4.8 |
| Fiber mass (g) | 131.1 | 256.7 | 262.7 |
| Sugar moisture (%) | 0.8 | 0.8 | 0.8 |
| Sugar mass (g) | 126.0 | 252.0 | 252.0 |
| Mixing and wetting in kitchen aid mixer | | | |
| Equipment model | Artisan | Artisan | Artisan |
| Mixing device | Kitchen Aid | Kitchen Aid | Kitchen Aid |
| Water added (g) | 147.4 | 168.0 | 134.7 |
| Final moisture of the granules after wetting (%) | 36.9 | 23.8 | 20.6 |
| Final mass of the granules after wetting (g) | 395.4 | 662.7 | 640.6 |
| Drying in Retsh fluidized bed | | | |
| Equipment model | RETSCH TG1 | RETSCH TG1 | RETSCH TG1 |
| Adjustment knob for heating output (scale 1-10) | 9.0 | 9.0 | 9.0 |
| Adjustment knob for blower output (scale 1-10) | 9.0 | 9.0 | 9.0 |
| Temperature controller (setpoint + actual scale 0- | 70.0 | 70.0 | 70.0 |
| 120° C.) | | | |
| Drying time (min) | 53.0 | 60.0 | 60.0 |
| Product temperature at the end of the drying (° C.) | 62.0 | 63.3 | 63.5 |
| Final product moisture at the end of the drying (%) | 1.6 | 2.1 | 1.9 |
| Cooling of the product | | | |
| Time required (min) | 30.0 | 30.0 | 30.0 |
| Final temperature (° C.) | 30.0 | 29.9 | 30.5 |
| Ambient temperature Dust room (° C.) | 29.6 | 29.0 | 30.0 |
| Milling using laboratory milling equipment | | | |
| Dx90 (microns) of sweetener composition | <50 | <50 | <50 |

And finally experiments were also carried out to prepare sweetener compositions in an AVA reactor/dryer:

| Sweetener | AVA Reactor/Dryer | | | | | | | |
|---|---|---|---|---|---|---|---|---|
| Composition | A1 | A1′ | A2 | A2′ | A3 | A3′ | A4 | A4′ |
| Bulking | RD | RD | ECP | ECP | MWB | MWB | MCS | MCS |
| agent | | | | | | | | |
| Sugar/ | 50/50 | 50/50 | 50/50 | 50/50 | 50/50 | 50/50 | 50/50 | 50/50 |
| Bulking | | | | | | | | |
| agent wt ratio | | | | | | | | |
| % seed | 40% | 71% | 10% | 30% | 10% | 30% | 10% | 30% |
| Type of seed | Silk | Silk | Silk | Silk | Silk | Silk | Silk | Silk |
| | sugar | sugar | sugar | sugar | sugar | sugar | sugar | sugar |
| Bulking | <100 μm | <40 μm | <40 μm | <40 μm | <40 μm | <40 μm | <40 μm | <40 μm |
| agent D90 | | | | | | | | |
| (μm) | | | | | | | | |
| Milling post | Yes | Yes | Yes | Yes | Yes | Yes | Yes | Yes |
| drying | | | | | | | | |

The process in the AVA reactor/dryer was carried out in following steps:
1. Preheated the reactor until the temperature in the drum reached 55-60° C.
2. Preheated the pump and pipe with hot water at 80° C.
3. Added the bulking agent together with seed through the filter nozzle into the drum in about 1 minute and agitated slowly with speed 80 rpm (mass of the product and seed according to the recipe).
4. Homogenized this mixture under atmospheric condition for about 15 minutes with agitator rotation speed of 120 rpm and installed chopper with rotation speed of 4000 rpm.
5. Product mixture was heated to a start drying temperature between 55-60° C. during mixing.
6. Vacuum unit was turned on. Pre-drying of the mixture under vacuum condition for 5 minutes.
7. Dosing pump was turned on to start spraying liquid sugar on the mixture during vacuum drying.
8. Pump was stopped to prevent spraying once the required mass of liquid sugar was reached, by weighing the liquid mass continuously.
9. Further vacuum drying until the final moisture content of the mixture was lower than 5 wt %.

Details of the AVA reactor/dryer reaction conditions:

| Sweetener Composition | A4 | | A4′ | | A2 | | A2′ | |
|---|---|---|---|---|---|---|---|---|
| Recipe name | MCS + | | MCS + | | ECP + | | ECP + | |
| | 10% seed | | 30% seed | | 10% seed | | 30% seed | |
| Mass of bulking agent | 1733 | g | 1733 | g | 1733 | g | 1733 | g |
| Mass of seed | 173 | g | 520 | g | 173 | g | 520 | g |
| Mass of liquid sugar | 3120 | g | 2400 | g | 3120 | g | 2400 | g |
| (syrup, 50% @75° C.) | | | | | | | | |
| Mixing time | 15 | min | 20 | min | 15 | min | 15 | min |
| Pre vacuum drying | 5 | min | 5 | min | 5 | min | 5 | min |
| Spraying of liquid sugar | 60 | min | 40 | min | 120 | min | 120 | min |
| (under vacuum) | | | | | | | | |
| Further vacuum drying | 35 | min | 25 | min | 15 | min | 10 | min |
| Total vacuum drying time | 100 | min | 70 | min | 140 | min | 135 | min |
| Finale moisture | 2.8 | wt % | 2.7 | wt % | 2.0 | wt % | 2.4 | wt % |
| Mass of final mixture | 3.36 | kg | — | | 3.38 | kg | 3.25 | kg |
| Incl. sieve result | 179 | g | — | | 7 | g | 80 | g |
| (with 1 mm mesh) | | | | | | | | |
| Final bulk density | 0.67 kg/I | | | | 0.6 kg/I | | | |
| Sweetener Composition | A1 | | A1′ | | A3 | | A3′ | |
| Recipe name | Fiber A + | | Fiber A + | | MWB + | | MWB + | |
| | 40% seed | | 71% seed | | 10% seed | | 30% seed | |
| Mass of bulking agent | 1733 | g | 1733 | g | 1733 | g | 1733 | g |
| Mass of seed | 693 | g | 1230 | g | 173 | g | 520 | g |
| Mass of liquid sugar | 2080 | g | 1000 | g | 3120 | g | 2400 | g |
| (syrup, 50% @75° C.) | | | | | | | | |
| Mixing time | 15 | min | 15 | min | 15 | min | 15 | min |
| Pre vacuum drying | 5 | min | 5 | min | 5 | min | 5 | min |
| Spraying of liquid sugar | 85 | min | 40 | min | 110 | min | 85 | min |
| (under vacuum) | | | | | | | | |
| Further vacuum drying | 35 | min | 20 | min | 20 | min | 20 | min |
| Total vacuum drying time | 125 | min | 65 | min | 135 | min | 110 | min |
| Finale moisture | 2.3 | wt % | 2.3 | wt % | 2.3 | wt % | 1.6 | wt % |
| Mass of final mixture | 2.54 | kg | 2.86 | kg | 3 | kg | 3 | kg |
| Incl. sieve result | 468 | g | 240 | g | 20 | g | 60 | g |
| (with 1 mm mesh) | | | | | | | | |

| | | |
|---|---|---|
| Final bulk density | 0.75 kg/I | 0.62 kg/I |

Note that the amount of seed used was higher for the mixture of resistant dextrin and silk sugar in the GLATT fluidized bed technology and in the AVA reactor, because
Very rapid crystallisation was needed to avoid the hygroscopic resistant dextrin from forming uneven lumps;
Increasing the amount of seed (dry sugar) will result in lowering the amount of liquid sugar to spray and consequently in lowering the amount of water put in the reactor and in avoiding lump formation

Note that two different amounts of seeding were tested in the AVA reactor.

### 3. Properties of the Obtained Sweetener Compositions

The DSC (Differential Scanning calorimetry) was measured to check the level of crystallinity in the samples. All DSC of the sweetener compositions showed evidence of crystallisation.

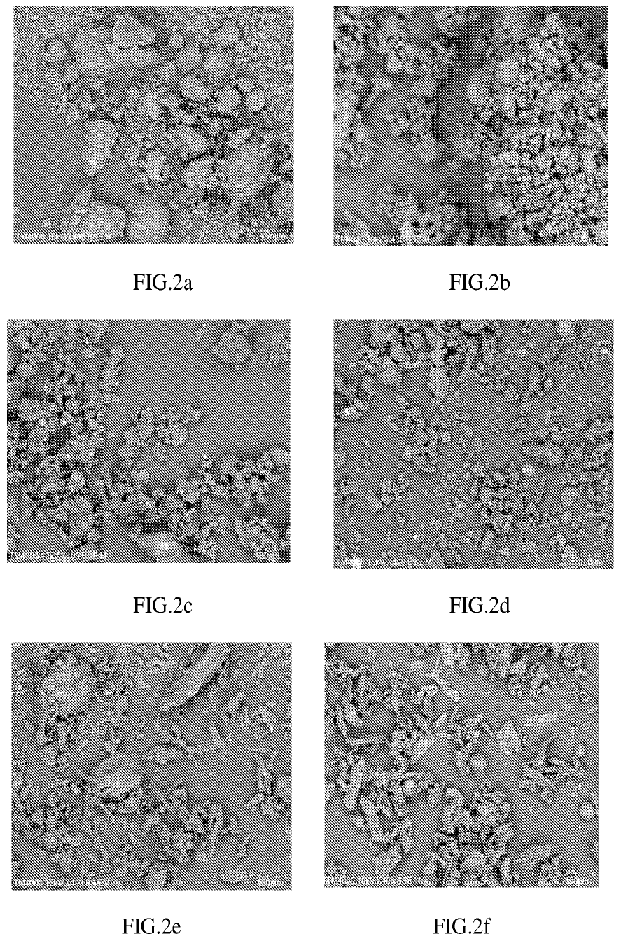

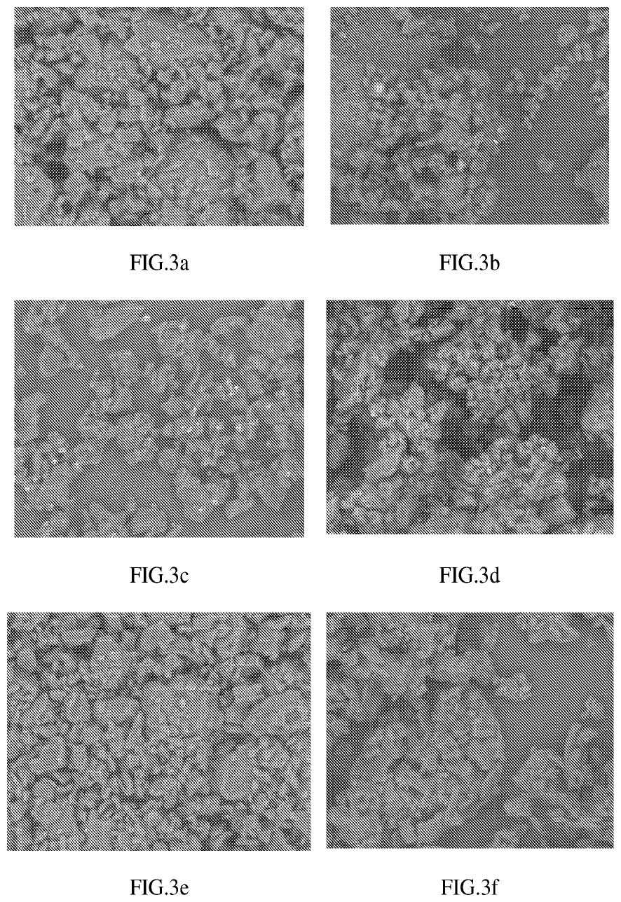

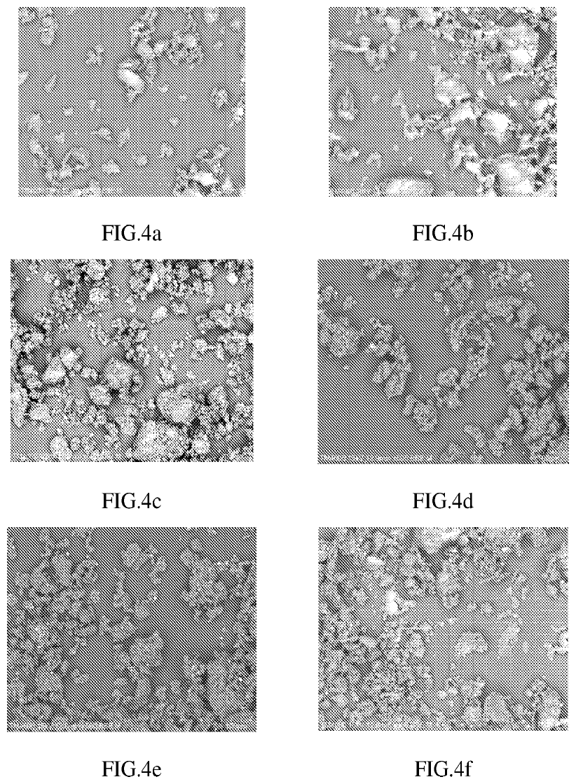

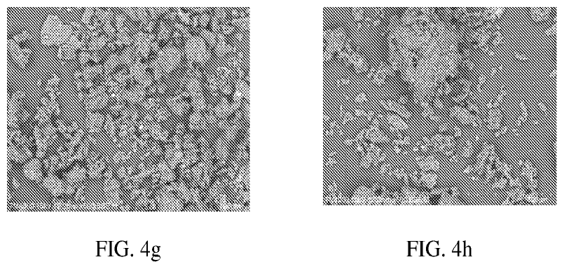

FIGS. 2a to 2f, FIGS. 3a to 3f and FIGS. 4a to 4h are images from the electron microscope of the sweetener compositions G1 to G6, R1 to R6, and A1 to A3.

| | Sweetener |
|---|---|
| FIGS. | Composition |
| 2a | G1 |
| 2b | G2 |
| 2c | G3 |
| 2d | G4 |
| 2e | G5 |
| 2f | G6 |
| 3a | R1 |
| 3b | R2 |
| 3c | R3 |
| 3d | R4 |
| 3e | R5 |
| 3f | R6 |
| 4a | A1 |
| 4b | A1′ |
| 4c | A2 |
| 4d | A2′ |
| 4e | A3 |
| 4f | A3′ |
| 4g | A4 |
| 4h | A4′ |

### 4. Preparation of Fat-Based Fillings

The following fat-based fillings were prepared according to the following recipes:

### Full Sugar Reference Filling

| | In wt % |
|---|---|
| Ingredients | |
| Icing sugar | 45.5 |
| Skimmed milk powder | 12 |
| Cocoa powder | 8 |
| Fat blend | 34 |
| Vanilla flavour | 0.1 |
| Lecithin | 0.5 |
| Nutritional profile | |
| Carbohydrates (in wt %) | 52.5 |
| Of which sugars (in wt %) | 51.6 |
| Protein (in wt %) | 6.1 |
| Fat (in wt %) | 35.4 |
| Fibre (in wt %) | 2.5 |
| Energy (kcal) | 558.8 |

Sugar-reduced fat-based fillings using the different Sweetener Compositions as described above were prepared according to the invention and are provided in the recipes below.

### Filling 1

| | In wt % |
|---|---|
| Ingredients | |
| Icing sugar | 9.1 |
| Resistant dextrin Sweetener Composition: | 36.4 |
| G1, R1, A1, or A1′ | |
| Skimmed milk powder | 12 |
| Cocoa powder | 8 |
| Fat blend | 34 |
| Vanilla flavour | 0.1 |
| Lecithin | 0.5 |
| Nutritional profile | |
| Carbohydrates (in wt %) | 51.6 |
| Of which sugars (in wt %) | 34.7 |
| Protein (in wt %) | 6.1 |
| Fat (in wt %) | 35.4 |
| Fibre (in wt %) | 16.5 |
| Energy (kcal) | 527.2 |
| SUGAR REDUCTION compared to | 32.7 |
| reference (%) | |

### Filling 2

| | In wt % |
|---|---|
| Ingredients | |
| Icing sugar | 12 |
| Exhausted Cocoa powder Sweetener | 35.5 |
| Composition: G2, R2, A2, or A2′ | |
| Skimmed milk powder | 12 |
| Cocoa powder | 8 |
| Fat blend | 32 |
| Vanilla flavour | 0.1 |
| Lecithin | 0.5 |
| Nutritional profile | |
| Carbohydrates (in wt %) | 39.0 |
| Of which sugars (in wt %) | 36.0 |
| Protein (in wt %) | 10.3 |
| Fat (in wt %) | 35.5 |
| Fibre (in wt %) | 9.6 |
| Energy (kcal) | 536.7 |
| SUGAR REDUCTION compared to | 30.4 |
| reference (%) | |

### Filling 3

| | In wt % |
|---|---|
| Ingredients | |
| Icing sugar | 13.3 |
| Micronized Wheat Bran Sweetener | 32.1 |
| Composition: G3, R3, A3, or A3′ | |
| Skimmed milk powder | 12 |
| Cocoa powder | 8 |
| Fat blend | 34 |
| Vanilla flavour | 0.1 |
| Lecithin | 0.5 |
| Nutritional profile | |
| Carbohydrates (in wt %) | 40.1 |
| Of which sugars (in wt %) | 36.0 |
| Protein (in wt %) | 8.5 |
| Fat (in wt %) | 36.2 |
| Fibre (in wt %) | 10.5 |
| Energy (kcal) | 539.7 |
| SUGAR REDUCTION compared to | 30.2 |
| reference (%) | |

### Filling 4

| | In wt % |
|---|---|
| Ingredients | |
| Icing sugar | 14.5 |
| Micronized Cocoa Sweetener | 31 |
| Composition: G4, R4, A4, or A4′ | |
| Skimmed milk powder | 12 |
| Cocoa powder | 8 |
| Fat blend | 34 |
| Vanilla flavour | 0.1 |
| Lecithin | 0.5 |
| Nutritional profile | |
| Carbohydrates (in wt %) | 37.4 |
| Of which sugars (in wt %) | 36.1 |
| Protein (in wt %) | 8.5 |
| Fat (in wt %) | 36.1 |
| Fibre (in wt %) | 12.5 |
| Energy (kcal) | 534.0 |
| SUGAR REDUCTION compared to | 30.0 |
| reference (%) | |

The following 4 fillings were made using dry-blends comprising silk sugar and a bulking agent in a 50/50 weight ratio. Bulking agents were dry-blended with silk sugar, an ultrafine crystalline milled sugar with a D50 of less than 8 microns. A standard blender, a Henschel Mixer®, was used for dry blending the materials until a homogenous dry blend of powder was obtained.

The blends prepared contained 50 wt % of bulking agent and 50 wt % of silk sugar. The resulting blends all had a D90 of less than 30 microns.

### Ref Filling 1

| | In wt % |
|---|---|
| Ingredients | |
| Icing sugar (and silk sugar from blend 1) | 27.3 |
| Resistant dextrin | 18.2 |
| Skimmed milk powder | 12.0 |
| Cocoa powder | 8.0 |
| Fat blend | 34.0 |
| Vanilla flavour | 0.1 |
| Lecithin | 0.5 |
| Nutritional profile | |
| Carbohydrates (in wt %) | 51.6 |
| Of which sugars (in wt %) | 34.7 |
| Protein (in wt %) | 6.1 |
| Fat (in wt %) | 35.4 |
| Fibre (in wt %) | 16.5 |
| Energy (kcal) | 527.2 |
| SUGAR REDUCTION compared to | 32.7 |
| reference (%) | |

### Ref Filling 2

| | In wt % |
|---|---|
| Ingredients | |
| Icing sugar (and silk sugar from blend 2) | 29.7 |
| Exhausted cocoa powder | 17.7 |
| Skimmed milk powder | 12.0 |
| Cocoa powder | 8.0 |
| Fat blend | 32.0 |
| Vanilla flavour | 0.1 |
| Lecithin | 0.5 |
| Nutritional profile | |
| Carbohydrates (in wt %) | 39.0 |
| Of which sugars (in wt %) | 36.0 |
| Protein (in wt %) | 10.3 |
| Fat (in wt %) | 35.5 |
| Fibre (in wt %) | 9.6 |
| Energy (kcal) | 536.7 |
| SUGAR REDUCTION compared to | 30.4 |
| reference (%) | |

### Ref Filling 3

| | In wt % |
|---|---|
| Ingredients | |
| Icing sugar (and silk sugar from blend 3) | 29.4 |
| Micronized wheat bran | 16.1 |
| Skimmed milk powder | 12.0 |
| Cocoa powder | 8.0 |
| Fat blend | 34.0 |
| Vanilla flavour | 0.1 |
| Lecithin | 0.5 |
| Nutritional profile | |
| Carbohydrates (in wt %) | 40.1 |
| Of which sugars (in wt %) | 36.0 |
| Protein (in wt %) | 8.5 |
| Fat (in wt %) | 36.2 |
| Fibre (in wt %) | 10.5 |
| Energy (kcal) | 539.7 |
| SUGAR REDUCTION compared to | 30.2 |
| reference (%) | |

### Ref Filling 4

| | In wt % |
|---|---|
| Ingredients | |
| Icing sugar (and silk sugar from blend 4) | 30.0 |
| Micronized cocoa shells | 15.5 |
| Skimmed milk powder | 12 |
| Cocoa powder | 8 |
| Fat blend | 34 |
| Vanilla flavour | 0.1 |
| Lecithin | 0.5 |
| Nutritional profile | |
| Carbohydrates (in wt %) | 37.4 |
| Of which sugars (in wt %) | 36.1 |
| Protein (in wt %) | 8.5 |
| Fat (in wt %) | 36.1 |
| Fibre (in wt %) | 12.5 |
| Energy (kcal) | 534 |
| SUGAR REDUCTION compared to | 30.0 |
| reference (%) | |

### 5. Method of Preparing the Fat-Based Fillings

In a first step, the dry ingredients were weighed out and mixed together. A partial amount of the fat blend was added.

Roll-refining of the mixture was carried out on a Buhler SDY-200. The target size after roll-refining was a D90 of 22-25 microns.

The remaining fat and lecithin emulsifier were then added and mixed until homogeneous.

### 6. Rheological Properties of the Prepared Fat-Based Fillings

The table below shows the Casson yield stress measured on the different Fillings 1 to 4. Fillings in the first series using resistant dextrin provides Casson yield stress closest to the full-sugar reference. Casson (Infinite shear) viscosity was also measured. Both Casson Yield and Casson (infinite shear) Viscosity were measured according to the IOCCC 2000 method calculated on the 4th interval.

| | Casson Yield | Casson |
|---|---|---|
| Filling | Stress (Pa) | Viscosity (Pa · s) |
| REFERENCE FILLING (full sugar) | 7.9 | 1.2 |
| FILLING 1 (with G1 (RD)) | 1.7 | 1.4 |
| FILLING 1 (with R1 (RD)) | 6.9 | 1.7 |
| FILLING 1 (with A1 (RD)) | 3.8 | 2.6 |
| FILLING 1 (with A1′ (RD)) | 4.6 | 2.3 |
| FILLING 2 (with G2 (ECP)) | 5.2 | 1.5 |
| FILLING 2 (with R2 (ECP)) | 3.6 | 1.2 |
| FILLING 2 (with A2 (ECP)) | 6.4 | 1.4 |
| FILLING 2 (with A2′ (ECP)) | 4.4 | 1.3 |
| FILLING 3 (with G3 (MWB)) | 7.3 | 2.0 |
| FILLING 3 (with R3 (MWB)) | 7.5 | 2.1 |
| FILLING 3 (with A3 (MWB)) | 14.4 | 1.7 |
| FILLING 3 (with A3′ (MWB)) | 6.4 | 1.7 |
| FILLING 4 (with G4 (MCS)) | 9.7 | 1.4 |
| FILLING 4 (with R4 (MCS)) | 2.4 | 0.9 |
| FILLING 4 (with A4 (MCS)) | 5.3 | 1.7 |
| FILLING 4 (with A4′ (MCS)) | 8.6 | 1.6 |

### 7. Sensory Results

A panel of 9 tasters evaluated the sensory properties of the Fillings 1 to 4 in comparison with the full sugar Reference Filling and in comparison with Ref Fillings prepared with dry-blends of silk sugar and the corresponding bulking agent in the same 50/50 ratio. The fillings were tasted in blind tasting sessions. The fillings were given a score of 1 to 5 (5 being the most similar to the reference) for the following sensory attributes:
Texture (melting in mouth, graininess; mouth coating; stickiness)
Off-taste (any bitter, wheaty, alcohol, burnt or other unpleasant after taste)
Sweetness (onset, intensity and duration)

A score of 5 was given to the Full Sugar Reference Filling on all 3 sensory attributes. The score out of 5 was then calculated as a percentage for the results obtained on the fillings using the blends according to the invention.

| | | Absence | | |
|---|---|---|---|---|
| | | of Off- | Sweet- | Reference |
| | Texture | taste | ness | score |
| REF FILING 1 with a dry- | 87.8% | 94.4% | 88.9% | 100.0% |
| blend of RD with silk sugar | | | | |
| 50/50 weight ratio | | | | |
| FILLING 1 (with G1 (RD)) | 64.4% | 93.3% | 90.0% | 100.0% |
| FILLING 1 (with R1 (RD)) | 81.1% | 92.2% | 87.8% | 100.0% |
| FILLING 1 (with A1 (RD)) | 84.4% | 94.4% | 95.6% | 100.0% |
| FILLING 1 (with A1′ (RD)) | 85.6% | 96.7% | 88.9% | 100.0% |
| REF FILING 2 with a dry- | 78.9% | 70.0% | 72.2% | 100.0% |
| blend of ECP with silk sugar | | | | |
| 50/50 weight ratio | | | | |
| FILLING 2 (with G2 (ECP)) | 80.0% | 76.7% | 66.7% | 100.0% |
| FILLING 2 (with R2 (ECP)) | 78.9% | 84.2% | 75.6% | 100.0% |
| FILLING 2 (with A2 (ECP)) | 70.0% | 85.6% | 73.3% | 100.0% |
| FILLING 2 (with A2′ (ECP)) | 83.3% | 73.3% | 68.9% | 100.0% |
| REF FILING 3 with a dry- | 83.3% | 73.3% | 78.9% | 100.0% |
| blend of MWB with silk sugar | | | | |
| 50/50 weight ratio | | | | |
| FILLING 3 (with G3 (MWB)) | 77.8% | 66.7% | 74.4% | 100.0% |
| FILLING 3 (with R3 (MWB)) | 85.6% | 82.8% | 85.6% | 100.0% |
| FILLING 3 (with A3 (MWB)) | 76.7% | 83.3% | 76.7% | 100.0% |
| FILLING 3 (with A3′ | 84.4% | 78.3% | 77.8% | 100.0% |
| (MWB)) | | | | |
| REF FILING 4 with a dry- | 83.3% | 51.1% | 57.8% | 100.0% |
| blend of MCS with silk sugar | | | | |
| 50/50 weight ratio | | | | |
| FILLING 4 (with G4 (MCS)) | 74.4% | 61.1% | 57.8% | 100.0% |
| FILLING 4 (with R4 (MCS)) | 78.9% | 60.0% | 62.2% | 100.0% |
| FILLING 4 (with A4 (MCS)) | 68.9% | 55.6% | 61.1% | 100.0% |
| FILLING 4 (with A4′ (MCS)) | 78.9% | 66.7% | 57.8% | 100.0% |

It can be seen here that the fillings with the sweetener compositions according to the invention comprising resistant dextrin and silk sugar performed the best overall.

What was highly unexpected is that the texture, off-taste and sweetness sensory results did not decrease by 30%, although the amount of sugar reduction was always at around 30-32% in each recipe. The combination of bulking agent with the silk sugar is surprisingly good at replacing 30 wt % or more of sugar in a recipe, whilst not impacting the taste, texture and sweetness by as much.

What was also highly unexpected is that the texture, off-taste and sweetness sensory results of the fillings could be substantially improved by the simultaneous crystallisation and drying technologies, such as the GLATT fluidised bed and the AVA reactor/dryer, and by the wet granulation and drying, such as the RETSCH fluidised bed, in comparison to the dry-blends of sugar and bulking agent.

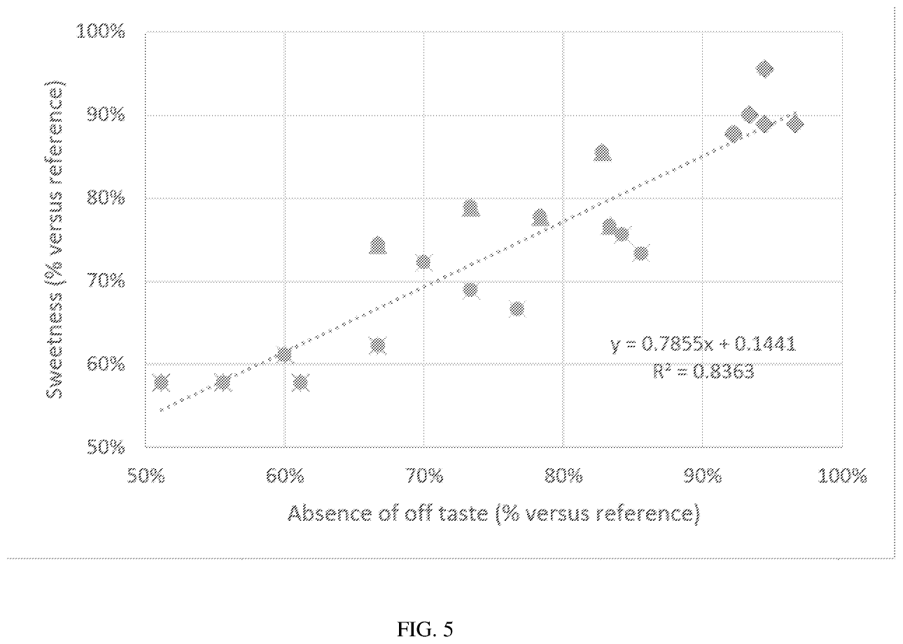

Furthermore, the inventors were surprised to note that the sweetness correlated with the off-taste. This can be seen in FIG. 5. (In this FIG. 5: squares represent the fillings with RD, triangles represent the fillings with ECP, diamonds represent the fillings with MWB, and crosses represent the fillings with MCS). Thus, for a given bulking agent having a specific off-taste, the sweetness can be predicted. Or, for a given bulking agent having a specific sweetness, the off-taste can be predicted.

1. A process for preparing a sweetener composition comprising one or more crystalline carbohydrate(s), the process comprising:
obtaining a solution of one or more carbohydrate(s) dissolved in a solvent, and
combining the solution with one or more bulking agent(s) and optionally one or more crystalline carbohydrate(s), to form a mixture, and
adjusting the temperature and/or concentration and/or solubility conditions of the solution and/or mixture such that crystallization of the carbohydrate occurs and a sweetener composition comprising one or more crystalline carbohydrate(s) is obtained.

2. A process according to claim 1, wherein the solution obtained is saturated with at least one of the one or more carbohydrate(s), and/or wherein the process further comprises a step of forming a solution saturated with at least one of the one or more carbohydrate(s).

3. A process according to claim 1, further comprising a step of drying the sweetener composition.

4. A process according to claim 1, wherein any two or more of the steps of the process occur simultaneously, sequentially, or non-sequentially.

5. A process according to claim 1, wherein the temperature is adjusted by cooling the mixture, and/or the concentration is adjusted by evaporating and/or applying a vacuum to the mixture, and/or wherein the solubility is adjusted by adding an antisolvent.

6. A process or sweetener composition according to claim 1, wherein the carbohydrate is selected from the group consisting of monosaccharides, disaccharides, polyols, and any combination thereof.

7. A process or sweetener composition according to claim 1, wherein the carbohydrate is sucrose.

8. A process according to claim 1, wherein the carbohydrate solution has a first temperature and the bulking agents(s) has a second temperature that is lower than the first temperature such that the mixture obtained by combining the carbohydrate solution with the one or more bulking agent(s) has an intermediate temperature, wherein the intermediate temperature is such that crystallization occurs.

9. A process according to claim 1, wherein one or more of the process steps are carried out using a dryer, preferably a fluidized bed dryer, dryer mixer, or dryer blender.

10. A process according to claim 1, wherein combining involves forming a suspension.

11. A process according to claim 1, wherein the sweetener composition has a D90 particle size of 150 microns or less.

12. A process according to claim 1, wherein at least 50% of the carbohydrate in the sweetener composition is in crystalline form.

13. A sweetener composition obtained or obtainable by the process of claim 1.

14. A food product comprising the sweetener composition of claim 13.

15. (canceled)
